(19) United States
(12) Patent Application Publication
(10) Pub. No.: US 2020/0399926 A1
(43) Pub. Date: Dec. 24, 2020

(54) DRIVABLE HANDLE STRUCTURE AND METHOD OF USE THEREOF

(71) Applicant: DTECH PRECISION INDUSTRIES CO., LTD., New Taipei City (TW)

(72) Inventor: TING-JUI WANG, New Taipei City (TW)

(21) Appl. No.: 16/884,074

(22) Filed: May 27, 2020

(30) Foreign Application Priority Data
Jun. 21, 2019 (TW) 108121858

(51) Int. Cl. E05B 1/00

(52) U.S. Cl. CPC E05B 1/003

(57) ABSTRACT

A drivable handle structure and method of use thereof are introduced, and the handle structure includes a shaft portion, a handle portion, and at least one lever portion; when the handle structure is used, the shaft portion is combined with a first object, and used as a rotating axis to make the lever portion turn for moving abuttingly against a movement portion of a second object so that the first object and the second object can move because of the movement of the handle structure. Accordingly, the handle structure may be set up to the first object, and drive or release from the second object so as to operate and apply force easily and have the advantage of convenient usage.

### CROSS-REFERENCE TO RELATED APPLICATION

This non-provisional application claims priority under 35 U.S.C. § 119(a) on Patent Application No(s). 108121858 filed in Taiwan, R.O.C. on Jun. 21, 2019, the entire contents of which are hereby incorporated by reference.

### BACKGROUND OF THE INVENTION

### 1. Field of the Invention

The present disclosure relates to a drivable handle structure and method of use thereof, and in particular to a drivable handle structure and method of use thereof which can set up the handle structure to a first object, and drive or release from a second object so as to operate and apply force easily and have the advantage of convenient usage.

### 2. Description of the Related Art

To facilitate carrying or handling general objects (e.g. chassis, box body, door body . . . ), handles are usually mounted on the objects so that the user can apply a force for use as carrying or handling.

However, in the case of the above-mentioned handle, it is fixed to the outside of the object with screws locking at both ends, and when used, the handle only can carry or handle one object, and cannot be combined to an object to drive another object, causing inconvenience in the use.

Thus, it is desirable to have a drivable handle structure and method of use thereof which can set up the handle structure to a first object, and drive or release from a second object so as to operate and apply force easily and have the advantage of convenient usage that is to be actively disclosed by the invention.

### BRIEF SUMMARY OF THE INVENTION

In view of the shortcomings of the above-mentioned prior art, the inventor felt that it was not perfect, and exhausted his mind to research carefully into a way for overcoming the problems, and then developed a drivable handle structure and method of use thereof which can set up the handle structure to a first object, and drive or release from a second object so as to operate and apply force easily and have the advantage of convenient usage.

To achieve the above objective and the other objectives, the present disclosure provides a drivable handle structure, and the handle structure comprises a shaft portion, a handle portion and a lever portion. The shaft portion is used to combine with a first object, and the lever portion is for abutting against a movement portion of the first object or a second object so that the first object or the second object can move because of the movement of the handle structure.

In an embodiment, the handle structure has one shaft portion and one lever portion, or the handle structure connects two shaft portions and two lever portions.

In an embodiment, the lever portion is a retractable structure.

In an embodiment, the retractable structure has a body portion or a rod portion, the rod portion has a head, and the rod portion combines movably with the body portion, and the rod portion can be retracted to the body portion or moved to the body portion.

In an embodiment, the handle structure further comprises an elastic element, and the elastic element abuts against the body portion with an end, and abuts against the rod portion with another end so that the rod portion is normally in a protruding position or normally in a shrink position.

In an embodiment, the head is a turning portion which is used to drive the rod portion retracting or protruding with an end abutting against the body portion when turning.

In an embodiment, the head is a pulling portion which is used to drive the rod portion retracting when pulling.

In an embodiment, the head or the body portion has a spiral portion which is used to drive the rod portion retracting or protruding when turning.

In an embodiment, the movement portion is strip-shaped, L-shaped, arc-shaped, curve-shaped, track-shaped, a slot, a groove, a through hole, a recess hole, a convex portion or a step portion.

In an embodiment, the second object is for carrying the first object.

In an embodiment, the handle structure has a fastening portion, and the fastening portion is a fastening body, a hook body, a thread body, a protrusion fastening body, a recess fastening body or a column.

In an embodiment, the shaft portion is a through hole, fastening body, convex body, concave body, groove portion, hitching body, pivoting body, hinge, turning body or rotating body.

In an embodiment, when the handle structure moves or turns, the shaft portion is used as fulcrum to make the lever portion produce power of leverage on the first object or the second object so as to labor-savingly push the first object or the second object moving.

In an embodiment, after the lever portion has finished the movement, the lever portion can be retracted so that there is no stopping or interference of the lever portion between the first object and the second object.

In an embodiment, the lever portion has the same axial direction as the shaft portion thereof.

In an embodiment, an angle between the lever portion and the handle portion is axially 90 degrees or close to 90 degrees.

In an embodiment, as the lever portion fails to retract, the first object and the second object cannot release from each other with stopping or interference.

In an embodiment, the lever portion is a rotatably retracting structure for rotating with no retraction to make the first object and the second object cannot release from each other with stopping or interference, or for rotating with retraction to make the first object and the second object can release from each other without stopping or interference.

In an embodiment, the handle structure further comprises an elastic element, and the elastic element abuts against the lever portion with an end, and abuts against the handle portion with another end to make the lever portion carry out an elastically reciprocating motion, automatically return motion, longitudinally reciprocating motion, laterally reciprocating motion or rotationally reciprocating motion.

The present disclosure further provides a method of use of a drivable handle structure, and the handle structure comprises a shaft portion, a handle portion and a lever portion. When the handle structure is used, the shaft portion is combined with a first object, and used as a rotating axis to make the lever portion move for moving abuttingly against a movement portion of the first object or a second object so that the first object or the second object can move because of the movement of the handle structure.

The present disclosure still provides a method of use of a drivable handle structure, and the handle structure comprises a shaft portion, a handle portion and a lever portion. When the handle structure is used, the shaft portion is combined with a first object, and used as a rotating axis to make the retractable lever portion move in a state of no retraction for moving abuttingly against a movement portion of the first object or a second object so that the first object or the second object can move because of the movement of the handle structure.

Therefore, the invention of the drivable handle structure and method of use thereof can set up the handle structure to a first object, and drive or release from a second object so as to operate and apply force easily and have the advantage of convenient usage.

### BRIEF DESCRIPTION OF THE DRAWINGS

FIG. 1 is a schematic external view according to a first embodiment of the present disclosure.

FIG. 2 is a schematic top view according to a second embodiment of the present disclosure.

FIG. 3 is a schematic external view 2 according to a second embodiment of the present disclosure.

FIG. 4 is a schematic view of the state of in use according to a second embodiment of the present disclosure.

FIG. 5 is a schematic top view according to a third embodiment of the present disclosure.

FIG. 6 is a schematic external view according to a third embodiment of the present disclosure.

FIG. 7 is a schematic view of the sectional state according to a fourth embodiment of the present disclosure.

FIG. 8 is a schematic external view according to a fourth embodiment of the present disclosure.

FIG. 9 is a schematic view showing different types of the fastening portion of the present disclosure.

FIG. 10 is a schematic external view according to a fifth embodiment of the present disclosure.

FIG. 11 is a schematic view 1 of the state of in use according to a fifth embodiment of the present disclosure.

FIG. 12 is a schematic view 2 of the state of in use according to a fifth embodiment of the present disclosure.

FIG. 13 is a schematic view of the sectional state according to a sixth embodiment of the present disclosure.

FIG. 14 is a schematic view of the sectional state according to a seventh embodiment of the present disclosure.

FIG. 15 is a schematic view of the sectional state according to an eighth embodiment of the present disclosure.

FIG. 16 is a schematic view of the sectional state according to a ninth embodiment of the present disclosure.

FIG. 17 is a schematic view of the sectional state according to a tenth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

Referring to FIG. 1, as shown in the drawing, the invention provides a drivable handle structure and method of use thereof, and the handle structure 1 comprises a shaft portion 11, a handle portion 12, and at least one lever portion 13; when the handle structure is used, the shaft portion 11 is combined with a first object, and a force is applied to the handle portion 12 and the shaft portion 11 is used as a rotating axis to make the lever portion 13 move for moving abuttingly against a movement portion of a second object (or the first object) so that the first object or the second object can move because of the movement of the handle structure 1 therebetween. Accordingly, the handle structure 1 may be set up to the first object, and drive or release from the second object so as to operate and apply force easily and have the advantage of convenient usage.

In a preferred embodiment of the invention, the handle structure 1 has one shaft portion 11 and two lever portions 13. The lever portion 13 has the same axial direction as the shaft portion 11 thereof, and an angle between the lever portion 13 and the handle portion 12 is axially 90 degrees or close to 90 degrees. Accordingly, the invention can further meet the requirement of practical application.

In a preferred embodiment of the invention, the shaft portion 11 may be a through hole, fastening body, convex body, concave body, groove portion, hitching body, pivoting body or hinge. Accordingly, the invention can further meet the requirement of practical application.

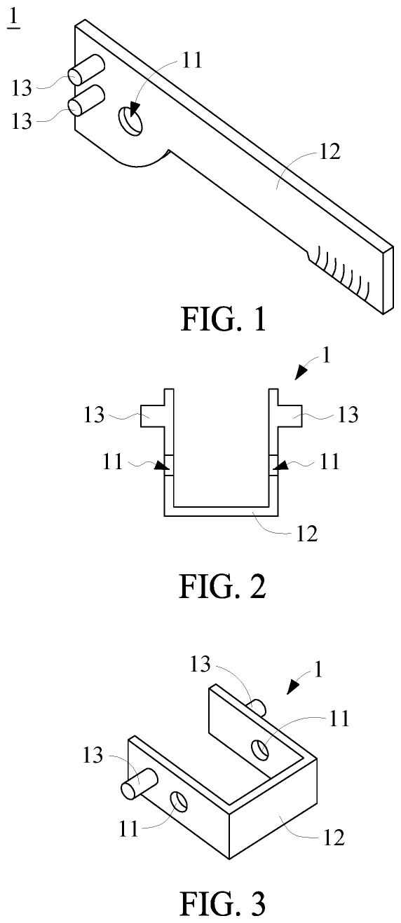

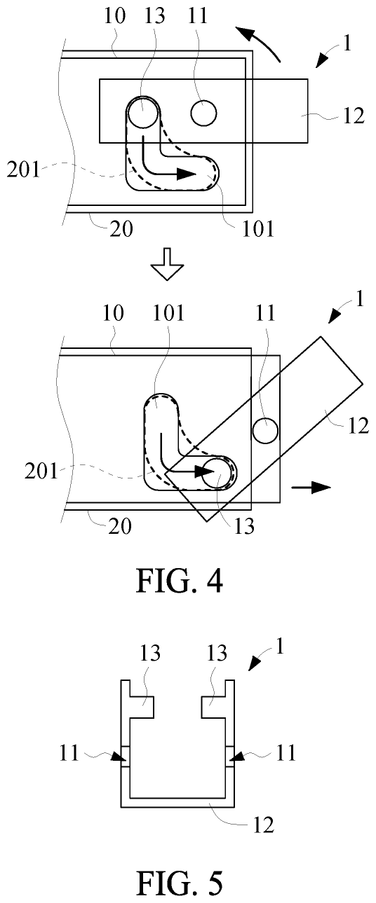

Referring to FIGS. 2-6, as shown in the drawings, the handle structure 1 connects two shaft portions 11 and two lever portions 13, the handle structure 1 is U-shaped, the shaft portions 11 are respectively set up to the handle structure 1 on the two sides, and the lever portions 13 are respectively set up with back to back to the handle structure 1 on the two sides in a preferred embodiment of the invention. When the handle structure is used, the second object 20 is for carrying the first object 10, the shaft portions 11 are combined with the first object 10, and a force is applied to the handle portion 12 and the shaft portions 11 are used as rotating axes to make the lever portions 13 turn for moving abuttingly against a movement portion 101 of the first object 10 and a movement portion 201 of the second object 20 so that when the handle structure 1 moves or turns, the shaft portions 11 are used as fulcrums to make the lever portions 13 produce power of leverage on the second object 20 so as to labor-savingly push the first object 10 moving, and drive the first object 10 and the second object 20 or release from each other, and thus the first object 10 and the second object 20 can move because of the movement of the handle structure 1. Accordingly, the handle structure 1 may be set up to the first object 10, and drive or release from the second object 20 so as to operate and apply force easily and have the advantage of convenient usage.

In a preferred embodiment of the invention, the movement portion 201 may be strip-shaped, L-shaped, arc-shaped, curve-shaped, track-shaped, a slot, a groove, a through hole, a recess hole, a convex portion or a step portion. Accordingly, the invention can further meet the requirement of practical application.

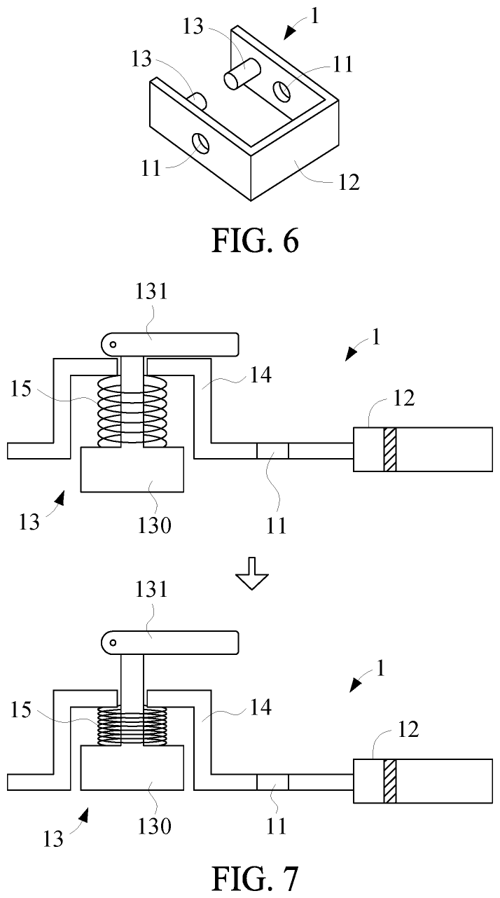

In addition, the lever portions 13 are respectively set up with back to back to the handle structure 1 on the two sides. Besides, the lever portions 13 can also be respectively oppositely set up to the handle structure 1 on the two sides (shown as FIGS. 5 and 6). Accordingly, the invention can further meet the requirement of practical application.

Referring to FIGS. 7-9, as shown in the drawings, in a preferred embodiment of the invention, the lever portion 13 is a retractable structure, the retractable structure has a body portion 14 and a rod portion 130, the rod portion 130 has a head 131, and the rod portion 130 combines movably with the body portion 14. The rod portion 130 can be retracted to the body portion 14 (or moved to the body portion 14), an elastic element 15 is further included therebetween, the elastic element 15 abuts against the body portion 14 with an end, and abuts against the rod portion 130 with another end so that the rod portion 130 is normally in a protruding position or normally in a shrink position, and the head 131 is a pulling portion which is used to drive the rod portion 130 retracting when pulling. As the rod portion 130 retracts, the first object releases from the second object without stopping or interference of the rod portion 130; as the rod portion 130 fails to retract, the first object and the second object cannot release from each other with stopping or interference. Accordingly, the handle structure 1 may be set up to the first object, and drive or release from the second object so as to operate and apply force easily and have the advantage of convenient usage.

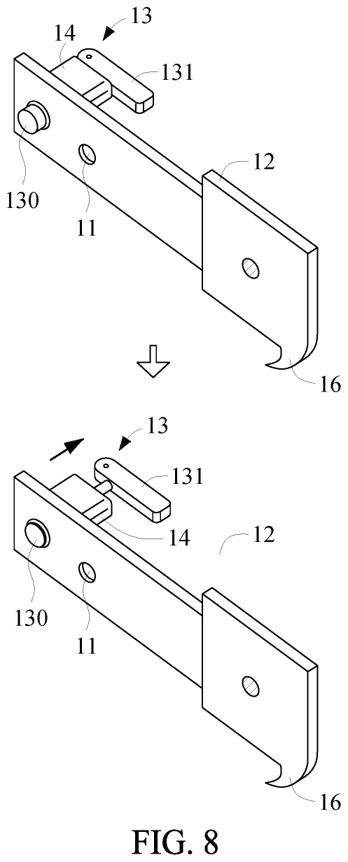

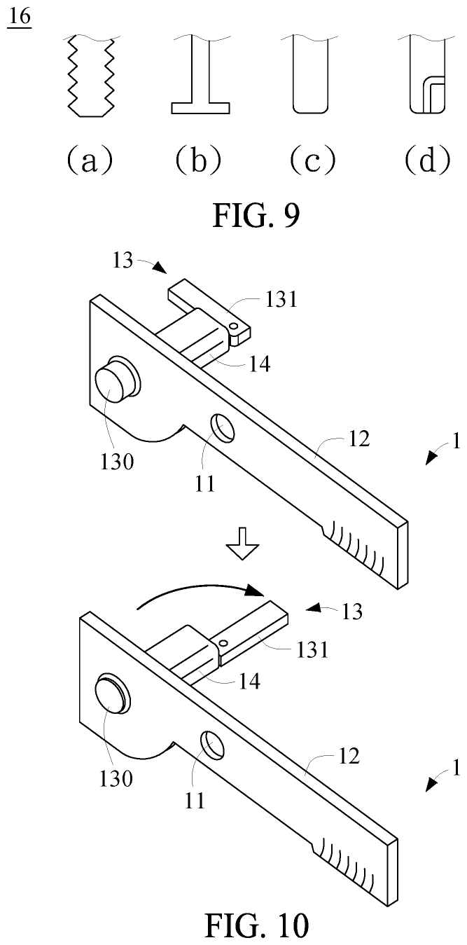

In a preferred embodiment of the invention, the handle structure 1 has a fastening portion 16, the fastening portion 16 can be put into practice to an end of the handle portion 12 to fasten the desired object (not shown in the drawings), and the fastening portion 16 may be a fastening body (or hook body as shown in FIGS. 7 and 8), a thread body (shown as (a) of FIG. 9), a protrusion fastening body (shown as (b) of FIG. 9), a recess fastening body (shown as (c) of FIG. 9) or a column (shown as (d) of FIG. 9). Accordingly, the invention can further meet the requirement of practical application.

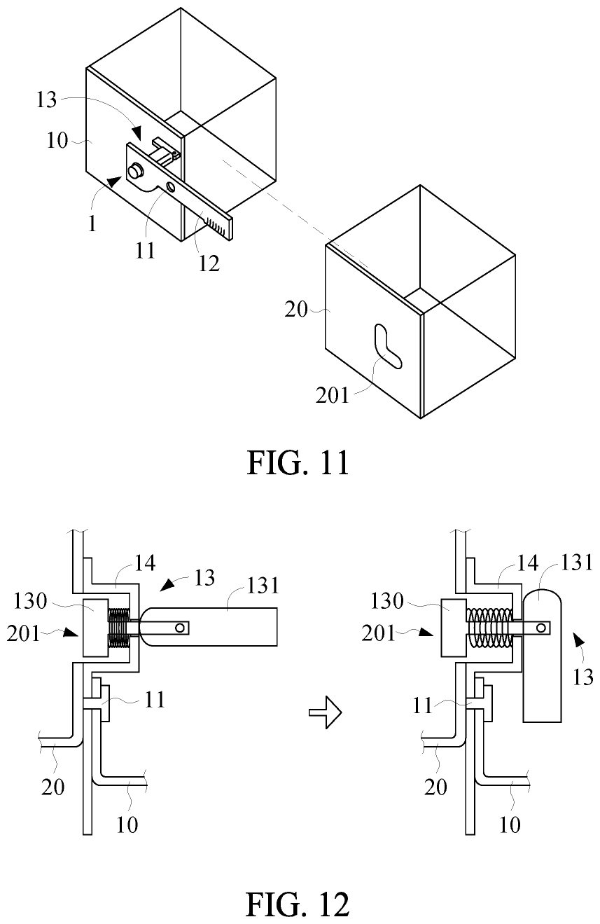

Referring to FIGS. 10-12, as shown in the drawings, in a preferred embodiment of the invention, the head 131 is a turning portion which is used to drive the rod portion 130 retracting or protruding with an end abutting against the body portion 14 when turning. When the handle structure is used, the second object 20 is for carrying the first object 10, and the shaft portion 11 is combined with the first object 10. As the rod portion 130 fails to retract (in the state of stretching out the body portion 14), the first object and the second object cannot release from each other with stopping or interference, and a force is applied to the handle portion 12 and the shaft portion 11 is used as rotating axis to make the lever portion 13 turn for moving abuttingly against a movement portion 201 of the second object 20 so that when the handle structure 1 moves or turns, the shaft portion 11 is used as fulcrum to make the rod portion 130 produce power of leverage on the second object 20 so as to labor-savingly push the first object 10 moving, and drive the first object 10 and the second object 20 or release from each other, and thus the first object 10 and the second object 20 can move because of the movement of the handle structure 1. After the rod portion 130 has finished the movement, the rod portion 130 can be retracted to the body portion 14 so that the first object 10 releases from the second object 20 without stopping or interference of the rod portion 130. Accordingly, the handle structure 1 may be set up to the first object 10, and drive or release from the second object 20 so as to operate and apply force easily and have the advantage of convenient usage.

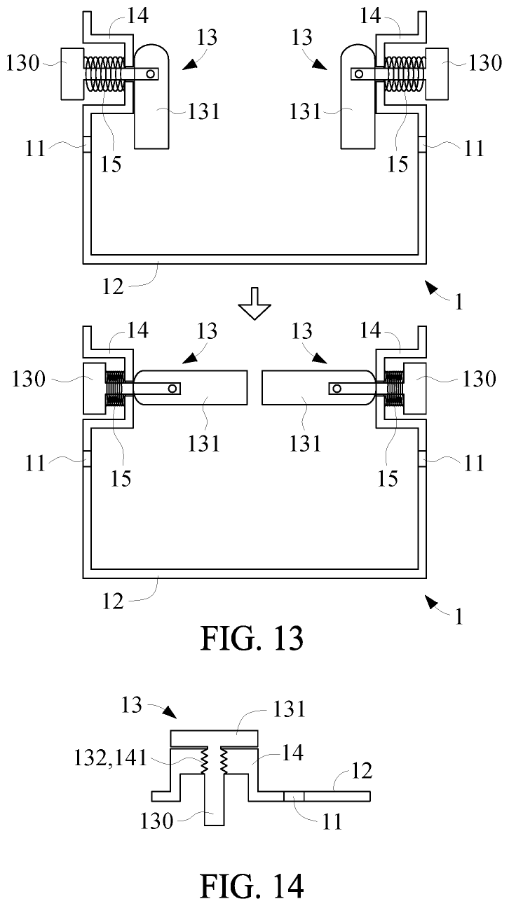

Referring to FIG. 13, as shown in the drawing, in a preferred embodiment of the invention, the handle structure 1 connects two shaft portions 11, two lever portions 13, two body portions 14 and two elastic elements 15, the handle structure 1 is U-shaped, the shaft portions 11 and the body portions 14 are respectively set up to the handle structure 1 on the two sides, and the lever portions 13 are respectively set up with back to back to the handle structure 1 on the two sides. When the handle structure is used, the second object 20 is for carrying the first object 10, the shaft portions 11 are combined with the first object 10. As the rod portion 130 fails to retract (in the state of stretching out the body portion 14), the first object and the second object cannot release from each other, and a force is applied to the handle portion 12 and the shaft portions 11 are used as rotating axes to make the rod portions 130 turn for moving abuttingly against a movement portion of the second object so that when the handle structure 1 moves or turns, the rod portions 130 are used as fulcrums to make the rod portions 130 produce power of leverage on the second object 20 so as to labor-savingly push the first object moving, and drive the first object and the second object or release from each other, and thus the first object and the second object can move because of the movement of the handle structure 1. After the rod portions 130 have finished the movement, the rod portions 130 can be retracted to the body portions 14 so that the first object 10 releases from the second object 20 without stopping or interference of the rod portion 130. Accordingly, the handle structure 1 may be set up to the first object 10, and drive or release from the second object 20 so as to operate and apply force easily and have the advantage of convenient usage.

Referring to FIG. 14, as shown in the drawing, in a preferred embodiment of the invention, there are spiral portions 132, 141 respectively between the head 131 and the body portion 14 that drive the rod portion 130 retracting when the head 131 turns so as to operate and apply force easily and have the advantage of convenient usage.

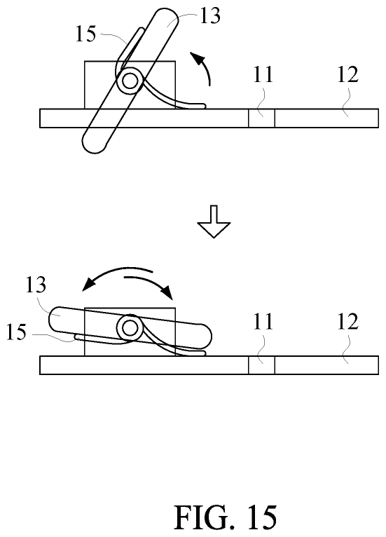

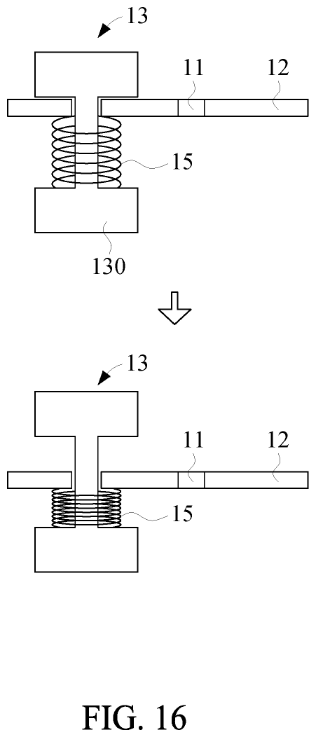

Referring to FIGS. 15 and 16, as shown in the drawings, in a preferred embodiment of the invention, the lever portion 13 is a rotatably retracting structure, the elastic element 15 abuts against the lever portion 13 with an end, and abuts against the handle portion 12 with another end for rotating with no retraction to make the first object and the second object cannot release from each other with stopping or interference, or for rotating with retraction to make the first object and the second object can release from each other without stopping or interference. Also, when the lever portion 13 actuates, the elastic element 15 carries out an elastically reciprocating motion, automatically return motion, longitudinally reciprocating motion, laterally reciprocating motion or rotationally reciprocating motion so as to operate and apply force easily and have the advantage of convenient usage.

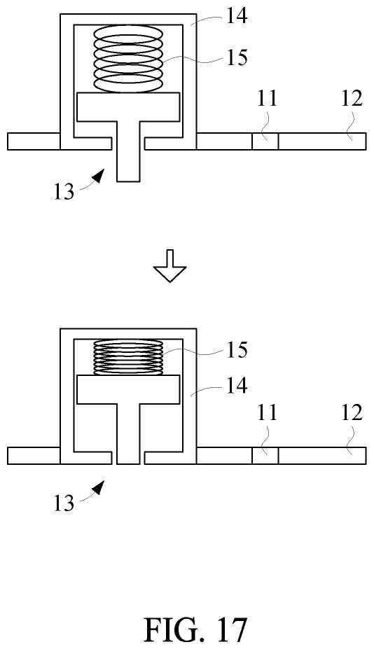

Referring to FIG. 17, as shown in the drawing, in a preferred embodiment of the invention, the elastic element 15 abuts against the lever portion 13 with an end, and abuts against the body portion 14 with another end. When the lever portion 13 actuates, the elastic element 15 carries out an elastically reciprocating motion, automatically return motion or longitudinally reciprocating motion so as to operate and apply force easily and have the advantage of convenient usage.

While the present disclosure has been described by means of specific embodiments, numerous modifications and variations could be made thereto by those skilled in the art without departing from the scope and spirit of the present disclosure set forth in the claims.

What is claimed is:

1. A drivable handle structure, comprising: a shaft portion, a handle portion and a lever portion, the shaft portion is used to combine with a first object, and the lever portion is for abutting against a movement portion of the first object or a second object so that the first object or the second object can move because of the movement of the handle structure.

2. The drivable handle structure according to claim 1, wherein the handle structure has one shaft portion and one lever portion, or the handle structure connects two shaft portions and two lever portions.

3. The drivable handle structure according to claim 1, wherein the lever portion is a retractable structure.

4. The drivable handle structure according to claim 3, wherein the retractable structure has a body portion or a rod portion, the rod portion has a head, and the rod portion combines movably with the body portion, and the rod portion can be retracted to the body portion or moved to the body portion.

5. The drivable handle structure according to claim 4, further comprising an elastic element, and the elastic element abuts against the body portion with an end, and abuts against the rod portion with another end so that the rod portion is normally in a protruding position or normally in a shrink position.

6. The drivable handle structure according to claim 4, wherein the head is a turning portion which is used to drive the lever portion retracting or protruding with an end abutting against the body portion when turning.

7. The drivable handle structure according to claim 4, wherein the head is a pulling portion which is used to drive the rod portion retracting or protruding when pulling.

8. The drivable handle structure according to claim 4, wherein the head or the body portion has a spiral portion which is used to drive the rod portion retracting or protruding when turning.

9. The drivable handle structure according to claim 1, wherein the movement portion is strip-shaped, L-shaped, arc-shaped, curve-shaped, track-shaped, a slot, a groove, a through hole, a recess hole, a convex portion or a step portion.

10. The drivable handle structure according to claim 1, wherein the second object is for carrying the first object.

11. The drivable handle structure according to claim 1, wherein the handle structure has a fastening portion, and the fastening portion is a fastening body, a hook body, a thread body, a protrusion fastening body, a recess fastening body or a column.

12. The drivable handle structure according to claim 1, wherein the shaft portion is a through hole, fastening body, convex body, concave body, groove portion, hitching body, pivoting body, hinge, turning body or rotating body.

13. The drivable handle structure according to claim 1, wherein when the handle structure moves or turns, the shaft portion is used as fulcrum to make the lever portion produce power of leverage on the first object or the second object so as to labor-savingly push the first object or the second object moving.

14. The drivable handle structure according to claim 3, wherein after the lever portion has finished the movement, the lever portion can be retracted so that there is no stopping or interference of the lever portion between the first object and the second object.

15. The drivable handle structure according to claim 1, wherein the lever portion has the same axial direction as the shaft portion thereof.

16. The drivable handle structure according to claim 1, wherein an angle between the lever portion and the handle portion is axially 90 degrees or close to 90 degrees.

17. The drivable handle structure according to claim 3, wherein as the lever portion fails to retract, the first object and the second object cannot release from each other with stopping or interference.

18. The drivable handle structure according to claim 1, wherein the lever portion is a rotatably retracting structure for rotating with no retraction to make the first object and the second object cannot release from each other with stopping or interference, or for rotating with retraction to make the first object and the second object can release from each other without stopping or interference.

19. The drivable handle structure according to claim 1, further comprising an elastic element, and the elastic element abuts against the lever portion with an end, and abuts against the handle portion with another end to make the lever portion carry out an elastically reciprocating motion, automatically return motion, longitudinally reciprocating motion, laterally reciprocating motion or rotationally reciprocating motion.

20. A method of use of a drivable handle structure, which uses the handle structure according to claim 1, wherein the shaft portion is combined with a first object, and used as a rotating axis to make the lever portion move for moving abuttingly against a movement portion of the first object or a second object so that the first object or the second object can move because of the movement of the handle structure.

21. A method of use of a drivable handle structure, which uses the handle structure according to claim 1, wherein the shaft portion is combined with a first object, and used as a rotating axis to make the retractable lever portion move in a state of no retraction for moving abuttingly against a movement portion of the first object or a second object so that the first object or the second object can move because of the movement of the handle structure.
